(19) United States
(12) Patent Application Publication
(10) Pub. No.: US 2015/0142581 A1
(43) Pub. Date: May 21, 2015

(54) Providing Ratings Using a Rating Service

(71) Applicant: AT&T Intellectual Property I, L.P., Atlanta, GA (US)

(72) Inventors: James W. Fan, San Ramon, CA (US); Jeffrey A. Aaron, Atlanta, GA (US); Venson Shaw, Kirkland, WA (US)

(73) Assignee: AT&T Intellectual Property I, L.P., Atlanta, GA (US)

(21) Appl. No.: 14/086,116

(22) Filed: Nov. 21, 2013

(51) Int. Cl. G06Q 30/02

(52) U.S. Cl. CPC G06Q 30/0269
USPC 705/14.66

(57) ABSTRACT

Concepts and technologies are disclosed herein for providing ratings using a rating service. A server computer can execute a rating service. The rating service can be configured to detect an activity associated with a user device and to identify a rating associated with the activity. The server computer can determine if the rating is to be provided to the user device and, if a determination is made that the rating is to be provided to the user device, provide the rating to the user device.

### BACKGROUND

The prevalence of portable communication devices and portable computing devices has increased dramatically over the past several years. Some consumers may own, carry, and use smartphones and other portable Internet-capable devices that may provide consumers with access to the Internet from almost any location. Thus, some modern consumers enjoy almost constant Internet access and/or connectivity. As a result, some consumers use portable Internet-capable devices to complete tasks at almost any location and at almost any time.

To meet these and other needs and desires of mobile device users, device manufacturers have enhanced the computing and connectivity abilities of these devices. In particular, the computing power of portable computing devices has been enhanced, as has the ability of communications networks to support frequent data communications with the portable computing devices. In addition to supporting various computing and connectivity functions, the almost-always-connected devices can be used by network operators to identify a geographic location of a computing or communication device at almost any time using various devices, systems, nodes, and/or networks of sensors.

Network operators can use information indicating a location of a user or user device for various functions. Network operations also may sell or otherwise leverage the information indicating a location of a user or user device to provide services for users and/or to monetize that information for other vendors. For example, a network operator may provide weather information to a mobile computing device based upon a location of the device, or provide the location information to a weather data provider to obtain weather information for the user or user device.

Similarly, a network operator may share the location information associated with a particular device with an advertiser or other entity to enable those entities to push relevant information to the device or device owner. Location based services can be used to tailor information presented at and/or provided by a portable computing device, as well as to market or monetize information associated with portable devices for various purposes. The network operators also may use the location information for network planning and/or resource optimization functions, among other things.

### SUMMARY

The present disclosure is directed to providing ratings using a rating service. A server computer can execute a rating service that can be used to provide ratings to user devices. As used herein, a “rating” can be used to refer to information, data, an indication, a representation, or the like, that explicitly or implicitly relates to an opinion or assessment of a value, utility, usefulness, worth, or other characteristic of an applicable product, service, activity, venue, vendor, company, or the like. Ratings can be defined in various ways such as, for example, number scales, grades, or other numerical ratings; numbers of stars, bars, or the like; letter ratings such as A through F and/or A⁺ through F, or the like; other scales or ratings such as good, fair, etc. or gold, silver, or the like; specific or general comments about an item or entity; combinations thereof; or the like. Ratings also can be explicit or implied, and one or more ratings may be considered together at times.

Ratings can relate to one or more aspects or dimensions of a product, service, or the like. The ratings also may have multiple aspects or dimensions. The ratings may be emotional and/or logical, highly subjective or somewhat objective, from a personal perspective or from a professional perspective. Thus, for example, ratings may be from one or more roles or personas of a rater or device associated with a particular rater. Ratings can be obtained by the server computer, for example via execution of the rating service, and stored in a database, data store, server, or other data storage device. The ratings can be used by the server computer and/or the rating service executed by the server computer for various reasons.

In some embodiments, the rating service can provide the ratings to a user device based upon an activity detected as being associated with the user device. The activity can include, for example, a geographic location of the user device, information indicating that the user device is interacting with a particular product or service, other contextual information, combinations thereof, or the like. As used herein, an “interaction” can include searching for prices, information, and/or reviews associated with the product or service; adding the product or service to a wish list or shopping cart; scanning a bar code, QR-code, or other visual indicia associated with the product or service; entering or moving within a venue or area associated with a particular good or service; web site access; combinations thereof; or the like.

The user device can generate a request for ratings via execution of a rating application by the user device. The rating application can track movements and/or interactions at the user device and determine, based upon these and/or other considerations, that a rating may be relevant to a user or other entity. In some embodiments, the request for ratings can be an explicit request generated by the user device. In some other embodiments, the rating service can be configured to track; alone or with the assistance of the rating application, location servers, and/or other devices, network components, and/or network nodes; that the ratings are to be provided. As such, the rating request can be implicit or explicit.

The rating service can identify relevant ratings and provide the ratings to the user device. In some embodiments, the user device can be configured to generate an alert to inform a user or other entity that ratings are available. The alerts can include audio, visual, and/or tactile alerts, as well as push notifications, emails, text messages, or the like. If the user or other entity confirms an interest in viewing the ratings, the ratings can be presented. In some embodiments, a user may delay viewing of the ratings. Thus, for example, a user can archive ratings for later viewing and/or interactions.

According to one aspect of the concepts and technologies disclosed herein, a method is disclosed. The method can include detecting, at a server computer executing a rating service, an activity associated with a user device, and identifying, by the server computer, a rating associated with the activity. The method also can include determining, by the server computer, if the rating is to be provided to the user device, and if a determination is made that the rating is to be provided to the user device, providing, by the server computer, the rating to the user device.

In some embodiments, the activity can include arrival at a geographic location. The rating can be associated with the geographic location. In some embodiments, the rating can include data identifying the geographic location and an item associated with the geographic location. The activity also can include an interaction with an item. The rating can be associated with the item.

In some embodiments, the interaction can include a web search relating to the item and a price search relating to the item. Identifying the rating can include determining that the item can be included in a shopping list associated with the user device. In some embodiments, the method also can include determining a location of the user device. Detecting the activity can include determining that the user device has arrived at the location. In some embodiments, determining the location of the user device can include receiving an indication, from a location device located at the location, that the user device has arrived at the location. In some embodiments, the location device can include a wireless location beacon.

In some embodiments, identifying the rating can include identifying a marketing option associated with a vendor. The marketing option can indicate that a rating is to be provided to the user device. In some embodiments, providing the rating to the user device can include providing, to the user device, data that causes the user device to generate a rating available alert and data corresponding to the rating. The rating available alert can include an alert selected from the group that includes a visual alert, a tactile alert, and an audio alert.

According to another aspect of the concepts and technologies disclosed herein, a system is disclosed. The system can include a processor and a memory storing computer-executable instructions. The computer-executable instructions, when executed by the processor, can cause the processor to perform operations including detecting an activity associated with a user device, identifying a rating associated with the activity, determining if the rating can be to be provided to the user device, and if a determination can be made that the rating can be to be provided to the user device, providing the rating to the user device.

In some embodiments, the system further can include a data store that stores ratings that can include the rating. Identifying the rating can include analyzing the ratings to identify an entity associated with a location at which the user device can be located, identifying an item on a shopping list associated with the user device, and determining that a rating relating to the item can be available. In some embodiments, the activity can include arrival at a geographic location associated with an item and interaction with the item. In some embodiments, identifying the rating can include determining that a vendor associated with item requests that the rating be provided to the user device.

According to yet another aspect, a computer storage medium is disclosed. The computer storage medium can have computer-executable instructions stored thereon. When the computer-executable instructions are executed by a processor, the processor can perform operations including detecting an activity associated with a user device, identifying a rating associated with the activity, determining if the rating can be to be provided to the user device, and if a determination can be made that the rating can be to be provided to the user device, providing the rating to the user device.

In some embodiments, identifying the rating can include analyzing social networking messages associated with the user device to identify an item, analyzing ratings stored in a data store to identify an entity associated with a location at which the user device can be located, identifying the entity as being associated with the item, and determining that ratings relating to the item can be available. In some embodiments, the computer storage medium further includes computer-executable instructions that, when executed by the processor, cause the processor to perform operations including providing data to the user device, wherein the data causes the user device to generate a rating available alert at the user device. In some embodiments, the rating available alert can include a vibration alert and a visual alert.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a system diagram illustrating an illustrative operating environment for the various embodiments disclosed herein.

FIG. 2 is a flow diagram showing aspects of a method for providing a rating, according to an illustrative embodiment.

FIG. 3 is a flow diagram showing aspects of a method for identifying a rating, according to another illustrative embodiment.

FIGS. 4A-4B are user interface (“UI”) diagrams showing aspects of UIs for providing ratings using a rating service, according to some illustrative embodiments.

FIG. 5 schematically illustrates a network, according to an illustrative embodiment.

FIG. 6 is a block diagram illustrating an example computer system configured to provide ratings using a rating service, according to some illustrative embodiments.

FIG. 7 is a block diagram illustrating an example mobile device configured to interact with a rating service, according to some illustrative embodiments.

### DETAILED DESCRIPTION

The following detailed description is directed to providing ratings using a rating service. A server computer can execute a rating service that can be used to detect when a user device is involved in an activity for which ratings may be relevant, and to provide ratings to the user device. The ratings provided by the server computer can be provided in response to determining the user device is interacting with a particular product, service, activity, or other entity or item; that the user device is approaching or has arrived at a geographic location associated with a particular product, service, venue, activity, or other entity or item; that a user is considering a purchase of a particular product, service, activity, or other entity or item; combinations thereof; or the like.

In some embodiments, venues, businesses, and/or vendors may operate location devices to detect presence of the user device, and presence of the user device at or near a particular location can be used to trigger the providing of ratings. Additionally, or alternatively, a location of a user device can be determined by the user device and/or various network elements, components, nodes, or the like, and provided to the rating service or the user device as location information.

As used herein, an “interaction” with a product, service, or other entity or item can include, but is not limited to, scanning visual indicia associated with the entity or item such as QR-codes, bar codes, labels, or the like; adding the entity or item, e.g., a product or service, to a shopping list, wish list, shopping cart, or the like; generating queries or accessing vendor websites for information associated with the entity or item; searching for prices, information, and/or reviews associated with the entity or item; combinations thereof; or the like. In some embodiments, vendors may also request that ratings be delivered to users at or near vendor locations, for example, when a user device enters the vendor location, or the like.

An activity associated with a user device can be detected by the rating service or by a rating application executed by the user device. The activity can include, for example, arrival at, movement within, exit from, and/or other activity at or near a geographic location; interactions with a product, service, service provider, item, or other entity; searches, scans, or other querying relating to a particular item or entity; combinations thereof; or the like. In some embodiments, the user device can generate an explicit request for a rating, and in some other embodiments, the rating service can determine that a rating is to be provided to the user device based upon an explicit or implicit request for ratings. Implicit requests can include determinations that the user device has arrived at or moved within a particular location; an indication that an interaction with a particular product, service, or other item or entity is occurring; a determination that social networking activity relating to a location, product, or other entity or item exists; combinations thereof; or the like.

The rating service can identify one or more ratings that are relevant to the activity detected and determine if the ratings are to be provided to the user device. The determination can be based upon various contextual information, as well as analysis of the stored ratings. If the ratings are to be provided to the user device, the rating service can transmit the ratings or data for generating a rating available alert. The alert can be generated at the user device and if the user or other entity wishes to view the rating, the rating can be downloaded (if not previously transmitted), or presented.

In some embodiments, the identification of the relevant ratings can be based upon the location of the user device, ratings stored by the rating service, entities associated with the location such as vendors or the like, marketing options for those entities such as options to push ratings to users, and shopping list, wish list, or contents of other entities such as shopping carts. Based upon these and other data, the rating service can identify relevant ratings and push those ratings to the user device.

Some embodiments of the concepts and technologies described herein support providing ratings to users in an effortless manner (from the perspective of the user), since ratings may be provided based upon monitoring location, activity, and/or other aspects of the user device without requiring any requests from the user or user device. In fact, ratings can be provided to users even if the users are unaware that relevant ratings exist and/or that particular products, services, activities, vendors, or the like are associated with a particular location.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

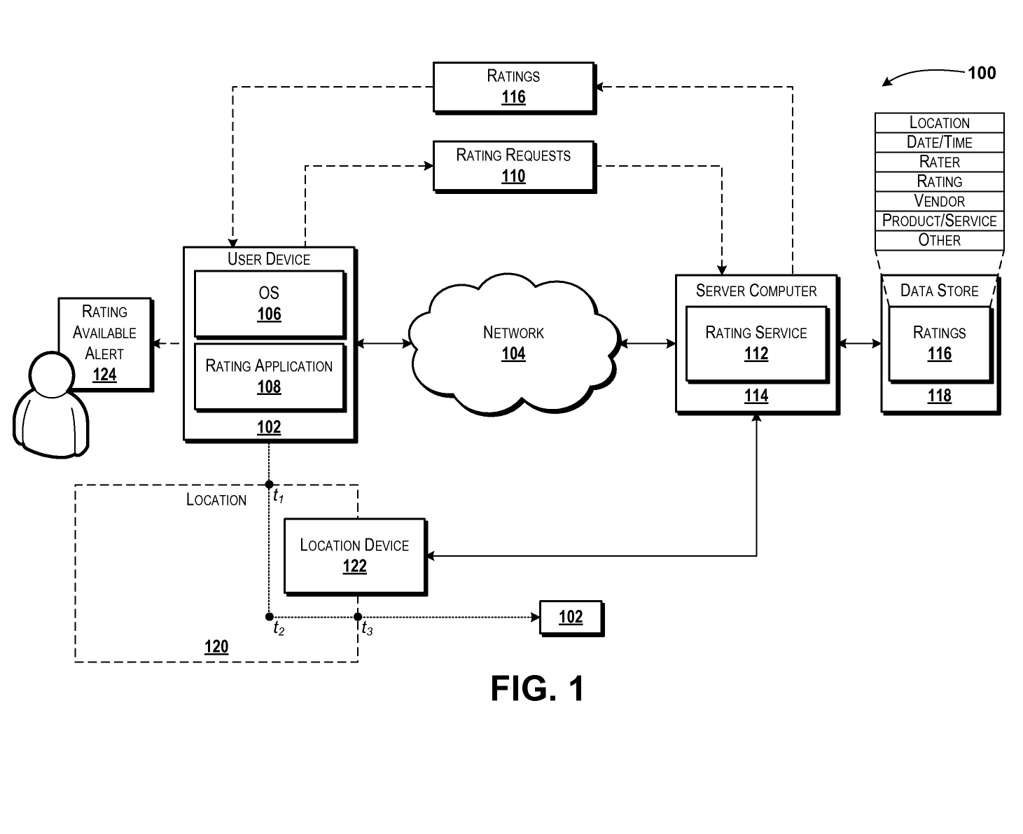

Referring now to FIG. 1, aspects of an operating environment 100 for various embodiments of the concepts and technologies disclosed herein for providing ratings using a rating service will be described, according to an illustrative embodiment. The operating environment 100 shown in FIG. 1 includes a user device 102 operating in communication with and/or as part of a communications network (“network”) 104. According to various embodiments, the functionality of the user device 102 may be provided by one or more mobile telephones, laptop computers, tablet computers, other computing systems, smartwatches, combinations thereof, or the like. For purposes of describing the concepts and technologies disclosed herein, the user device 102 is described herein as a smartphone. Because other devices can be configured to provide the functionality described herein with respect to the user device 102, it should be understood that this example is illustrative and therefore should not be construed as being limiting in any way.

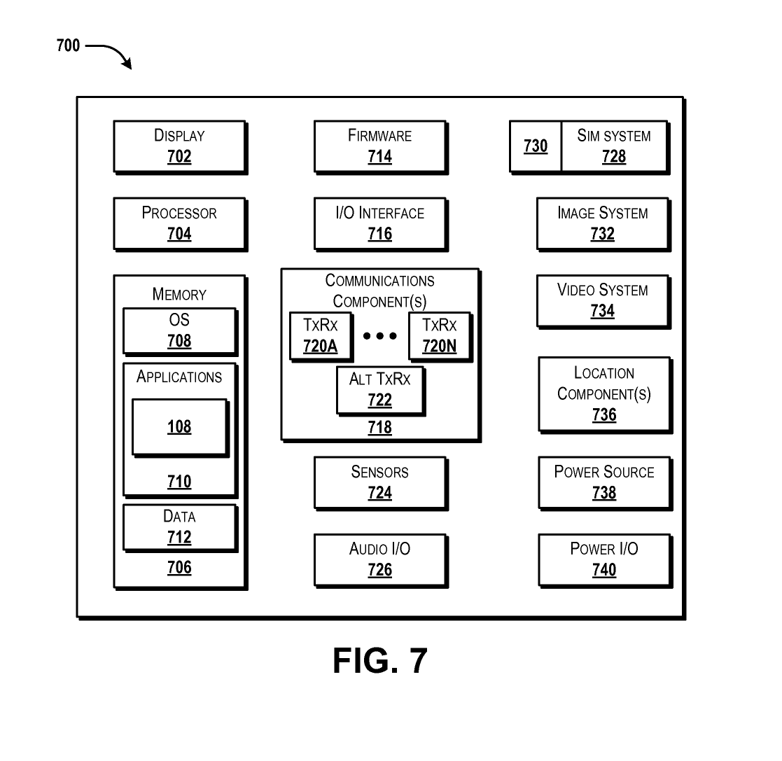

The user device 102 can execute an operating system 106 and one or more application programs such as, for example, a rating application 108. The operating system 106 is a computer program for controlling the operation of the user device 102. The rating application 108 can include an executable program configured to execute on top of the operating system 106 to provide various functions as described herein for providing ratings. The user device 102 also can execute other application programs such as, for example, web browsers, shopping applications, media capture applications, web applications or “apps,” combinations thereof, or the like. Some additional application programs and/or components and functionality of the user device 102 will be illustrated and described herein, particularly with reference to FIG. 7.

The rating application 108 can be configured to monitor geographic locations, movements, interactions, and/or various other activities associated with the user device 102. The ratings application 108 also can be configured to obtain ratings relevant to determined locations, movements, interactions, and/or activities, and to present the ratings at the user device 102. The rating application 108 also can be configured to generate ratings based upon activities of the user device 102. Some aspects of generating ratings are addressed below.

According to various embodiments of the concepts and technologies described herein, the user device 102 can be configured to generate a rating request 110 based upon activities or locations of the user device 102. The rating request 110 can indicate a context, location, activity, and/or other information associated with the user device 102. The rating request 110 can request one or more ratings relevant to the context, location, activity, and/or the like. The rating request 110 can correspond to an explicit request for a rating generated at the user device 102, for example by a user or other entity requesting a rating, or can be generated based upon implicit information such as the location of the user device 102, movements of the user device 102, an activity or activities occurring with the user device 102, combinations thereof, or the like. Because the rating request 110 may be omitted in some embodiments, or may be generated elsewhere such as by a node of the network 104, it should be understood that this example is illustrative and therefore should not be construed as being limiting in any way.

In some embodiments of the concepts and technologies described herein, the rating application 108 can be configured to monitor activity occurring at the user device 102. For example, the rating application 108 can be configured to detect product searches or queries, price checks or scans, and/or other commerce-related activity that can be understood, by the rating application 108, to indicate that a user or other entity associated with the user device 102 is considering purchasing a product or service, or is interested in other entities or items that may be associated with ratings. Based upon these and other considerations, the rating application 108 can determine that a rating may be relevant to the user or other entity, and generate and/or submit the rating request 110 to a rating service 112 or other entity.

In some embodiments, the rating request 110 can be implicitly generated by the rating service 112. For example, the rating service 112 may determine, based upon activity of the user device 102, that ratings 116 are to be provided without receiving a rating request 110. Thus, it can be appreciated that the illustration of a rating request 110 can be illustrative of one embodiment, or that the illustrated rating request 110 can be conceptual, in some embodiments. As such, the illustrated embodiment of FIG. 1 should not be construed as being limiting in any way.

According to various embodiments, the rating service 112 can include a server application or module executed or hosted by a computing device such as a server computer 114. According to some embodiments, the rating service 112 can be a callable service that can be configured to determine if a rating associated with the product, service, vendor, activity, and/or other item or entity is available. In some embodiments, a vendor associated with the product, service, venue, activity, or the like may provide or request ratings from one or more customers, reviewers, raters, or the like.

The rating service 112 can be configured to store the ratings 116 in a data storage device such as a data store 118, or the like. According to various embodiments, the ratings 116 can be stored with data or other information that associates the ratings 116 with and/or defines for a particular rating, a location, a date and/or time, an entity that submitted the rating (e.g., a rater), an actual score or rating (“rating”), a vendor associated with the rating, a product or service associated with the rating, other information (“other”), combinations thereof, or the like. The ratings 116 can be stored in a table, database, or other data structure that can support querying and/or other lookup operations. As such, the ratings 116 can be searched according to various aspects of the ratings 116, and as such, the rating service 112 can identify relevant ratings 116 based upon various aspects of the ratings 116 including, but not limited to, time, date, location, rater, rating, vendor, item or entity, or the like. The rating service 112 can be configured to control storage of the ratings 116, in some embodiments, though this is not necessarily the case.

The rating service 112 can be configured to determine, based upon the rating requests 110 and/or based upon other considerations, if relevant ratings 116 exist in the data store 118. The rating service 112 can identify relevant ratings 116 and provide the ratings 116 to entities when determined by the rating application 108 and/or the rating service 112 to be relevant to a user of the user device 102.

In some embodiments, the rating service 112 can be configured to interact with the rating application 108 to determine if a rating 116 is relevant to an activity of the user device. The rating service 112 also can be configured to interact with the rating application 108 to provide one or more of the ratings 116 to the user device 102 if relevant ratings 116 are identified. Thus, various embodiments of the concepts and technologies described herein can support surfacing of ratings 116 at relevant times in response to explicit request for the ratings 116 by a user or other entity and/or in response to implicit requests for the ratings 116, for example, requests based upon context, movement, location, and/or the like, associated with the user device 102. Because the ratings 116 can be provided at additional and/or alternative times, it should be understood that this example is illustrative and therefore should not be construed as being limiting in any way.

As noted above, the rating application 108 can be configured to receive the ratings 116 at relevant times and/or situations without submitting the rating request 110 or other data to the rating service 112. In particular, the rating service 112 can be configured to monitor activities of the user device 102 and provide ratings 116 when the ratings 116 are expected or determined to be relevant. The rating service 116 can monitor the activities of the user device 102 via communication with the user device 102 and/or the rating application 108 executed by the user device 102, or via communication with other systems, nodes, devices, or the like.

In one contemplated embodiment of the concepts and technologies described herein, the rating service 112 can be configured to communicate with location servers to track locations and/or movements of the user device 102, and to determine, based upon location information received from the location server, that the user device 102 has moved into, near, within, and/or at a particular location 120. The location 120 can include, for example, a retail store, a warehouse, a mall, and/or other locations that may be associated with a particular vendor, activity, service, product, and/or other entity that may be the subject of one or more ratings.

In some other embodiments, the rating service 112 can communicate with one or more location devices 122 located at or near the location 120. The location device 122 can include, for example, location determination devices such as femto-cells or the like, WiFi routers, BLUETOOTH beacons, radio frequency identification (“RFID”) tags, near field communications (“NFC”) devices, combinations thereof, or the like. In some embodiments, the location devices 122 can be configured to detect a user or other entity entering, moving within, and/or leaving a geographic location that corresponds with and/is otherwise associated with the vendor by detecting connection of a device such as the user device 102 with one or more of the location devices 122.

The location devices 122 can communicate with the rating service 112 to indicate the presence or approach of the user device 102, and the rating service 112 can determine, based upon a known or determined location of the user device 102, if relevant ratings 116 are available. Thus, for example, the rating service 112 can determine, on its own and/or based upon communication with one or more location devices 122, that the user device 102 entered the location 120 at a first time t₁, moved within or interacted with an item at the location 120 at a second time t₂, and left the location 120 at a third time t₃. It should be understood that this example is illustrative and therefore should not be construed as being limiting in any way.

The rating service 112 can be configured to identify ratings 116 that are relevant to an activity associated with the user device 102 based upon the location, interactions at the location 120, and/or other considerations. As used herein, the term “interaction” and variants thereof can be used to refer to activities associated with the user device 102 that can be interpreted by the rating service 116 as indicating that the user or other entity associated with the user device 102 is considering a purchase of a product, service, activity, or other entity or item.

For example, if a user device 102 is used to search for a price of a product, service, activity, or the like, for example by scanning a bar code, QR-code, or the like, the rating application 108 and/or the rating service 112 can determine that the user of the user device 102 is considering a purchase of the product or service. Similarly, if the user device 102 is used to perform a query relating to a vendor, provider, venue, or the like associated with a particular location, the rating application 108 and/or the rating service 112 can determine that a purchase relating to a product, service, activity, or other entity or item is being considered. Other contemplated interactions include, but are not limited to, social networking posts or messages relating to a product or service, searches or queries relating to products or services, and/or other searches, queries, or other activities associated with locations, services, products, activities, combinations thereof, or the like. Because the interactions can include additional and/or alternative activities, it should be understood that these embodiments are illustrative, and should not be construed as being limiting in any way.

Although the rating service 112 is illustrated as a component of the server computer 114, it should be understood that the rating service 112 may be embodied as or in a stand-alone device or component thereof operating as a part of or in communication with the network 104 and/or the user device 102. As such, the illustrated embodiment should be understood as being illustrative of only some contemplated embodiments and should not be construed as being limiting in any way.

The rating application 108 can be configured to obtain the ratings 116, either in response to a rating request 110 and/or in response to the ratings 116 being sent to the user device 102 by the rating service 112. The rating application 108 can be configured to generate a notification to the user or other entity such as, for example, a rating available alert 124. The rating available alert 124 can indicate to a user or other entity that a rating 116 is available and/or that a rating 116 is relevant to an activity, location, vendor, venue, service, product, other item or entity, or other contextual consideration associated with the user device 102.

According to various embodiments of the concepts and technologies described herein, the rating available alert 124 can be configured by application settings, configurations, preferences, software settings, device settings, network operator preferences, or the like. The ratings available alert 124 can be presented as visual alerts such as blinking lights, user interface elements or screen displays, light emitting diodes (“LEDs”), or the like; push notifications, emails, text messages, or the like; audio alerts such as rings, beeps, other audio sounds, or the like; tactile alerts such as vibrations or the like; combinations thereof; or the like. In some embodiments, the rating available alert 124 can be invasive to ensure that the user or other entity is aware that the ratings 116 are available, while in some other embodiments, the rating available alert 124 can be noninvasive to attempt to reduce the chance that a user or other entity is unnecessarily bothered by the rating available alert 124. These and other aspects of the rating application 108 can be user-defined and/or controlled to meet needs and preferences of a user, software developer, network operator, combinations thereof, or the like.

In practice, the server computer 114 can execute the rating service 112 to obtain and provide ratings to users and/or other entities. The ratings obtained by the server computer 114 can indicate, among other things, a geographic location (“location”) associated with a particular rating; a date and time associated with the rating; a rater or other entity associated with the rating 116, a score or other value indicator (“rating”); a vendor or other entity such as manufacturer, service provider, or other entity that provides the product, service, or activity associated with the rating 116; a product, service, activity, or other entity (“product/service”) associated with the rating 116; other information associated with the rating 116; combinations thereof; or the like. One contemplated method for providing the ratings 116 to the rating service 112 is illustrated and described in U.S. patent application Ser. No. 13/705,442, filed on Dec. 5, 2012 and entitled “Obtaining Ratings Using a Rating Service,” which is incorporated herein by reference in its entirety.

The rating service 112 can store the ratings 116 in a data storage device or location such as the data store 118. The ratings 116 can be stored in a searchable format that can support queries against any aspect of the ratings 116 such as, for example, location, date, time, or the like. The ratings 116 can be created, updated, deleted, and/or otherwise modified by qualified users at almost any time.

A user device 102 can execute the rating application 108. The rating application 108 can be configured to monitor activity of the user device 102 and/or a user thereof, or to communicate with the rating service 112 to provide the functionality disclosed herein. At some point in time, the user device 102 may approach, enter, exit, or move within a location such as the location 120. The location 120 can correspond to a venue, a retail location, a warehouse, an activity site, an office, a service provider facility, combinations thereof, or the like. The rating application 108 and/or the rating service 112 can determine that the user device 102 has entered or otherwise come within a proximity of the location 120.

In response to this and/or other determinations, the rating application 108 can generate a rating request 110 and transmit the rating request to the user device 102. The rating request 110 can indicate that the user device 102 is at or near the location 120, and request ratings 116 relevant to the location 120 and/or the status of the user device 102. In some other embodiments, the rating service 112 can monitor movements and/or activities of the user device 102 and determine, based upon the movements and/or other activities that the ratings 116 are to be provided to the user device 102. As such, it should be understood that the rating service 112 can push ratings 116 to the user device 102 with or without receiving the rating request 110.

In some embodiments, the rating application 108 and/or the rating service 112 can determine that the user device 102 is at or near the location 120 based upon explicit location information provided by the user device 102, by location information determined by the rating service 112 and/or other entities such as location servers, or the like; and/or by communicating with one or more location devices 122 such as a BLUETOOTH beacon, NFC device, combinations thereof, or the like. Based upon the presence of the user device 102 at or near the location 120 as well as other data such as shopping lists, shopping carts, wish lists, buying histories or patterns, combinations thereof, or the like, the rating application 108 and/or the rating service 112 can determine that a rating 116 is or may be relevant to the user.

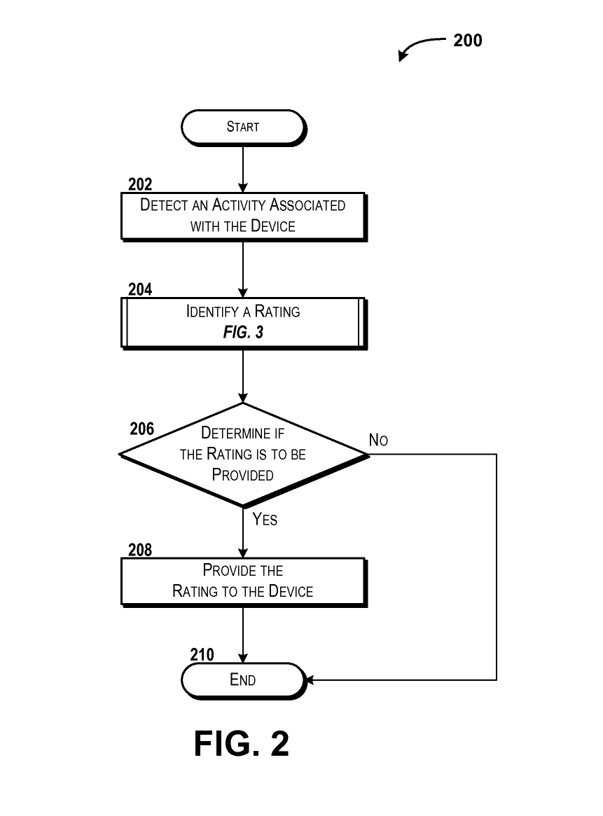

Upon determining that rating 116 is or may be relevant to the user device 102, the rating service 114 can package the rating 116 and/or ratings 116, and provide the ratings 116 to the user device 102 for presentation at the user device 102. In some embodiments, the rating application 108 can be configured to generate and provide a rating available alert 124 such as a blinking LED, a tactile alert such as a vibration alert, a beep, ring, or other audio sound, a graphic user interface or screen display, combinations thereof, or the like. A user or other entity associated with the user device 102 can select an option to view the rating 116 and the rating can be presented at the user device 102. These and other aspects of the rating service 112 and/or the rating application 108 will be illustrated and described in additional detail below, particularly with reference to FIGS. 2-4B.

FIG. 1 illustrates one user device 102, one network 104, one server computer 114, one data store 118, one location 120, and one location device 122. It should be understood, however, that various implementations of the operating environment 100 include zero, one, or more than one user device 102, zero, one, or more than one networks 104, zero, one, or more than one server computer 114, zero, one, or more than one data store 118, zero, one, or more than one location 120, and/or zero, one, or more than one location device 122. As such, the illustrated embodiment should be understood as being illustrative, and should not be construed as being limiting in any way.

Turning now to FIG. 2, aspects of a method 200 for providing a rating will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as, the user device 102 or the server computer 114 to perform one or more operations and/or causing the processor to direct other components of the computing system or device to perform one or more of the operations.

For purposes of illustrating and describing the concepts of the present disclosure, the methods disclosed herein are described as being performed by the server computer 114 via execution of one or more software modules such as, for example, the rating service 116. It should be understood that additional and/or alternative devices and/or network nodes can provide the functionality described herein via execution of one or more modules, applications, and/or other software including, but not limited to, the rating service 116. Thus, the illustrated embodiments are illustrative, and should not be viewed as being limiting in any way.

The method 200 begins at operation 202. At operation 202, the server computer 114 can detect an activity associated with a device such as, for example, the user device 102. The activity detected in operation 202 can correspond, according to various embodiments of the concepts and technologies described herein, movements, interactions, communications, combinations thereof, or the like. In some embodiments, the activity detected in operation 202 can correspond to commerce activity associated with the user device 102. For example, the activity detected in operation 202 can correspond to a purchase; a price check or web search relating to a product, activity, service, service provider, venue, or the like; other interactions with products, services, or other items or entities; arrival at and/or movement within or near a particular location; an explicit request to obtain a rating such as the rating request 110 shown in FIG. 1; combinations thereof; or the like.

According to various embodiments, wherein the activity detected in operation 202 can correspond to an interaction between the user device 102 and a product, service, or other item or entity, the server computer 114 can detect an interaction with the product or other entities or items. As noted above, the item or entity interacted with can include a product, service, venue, vendor, or the like. Thus, the interaction can include a barcode scan, a query or search, a social networking post, a QR-code scan, a label or other optical indicia scan, access to a website associated with a vendor or venue, a price scan or search, an addition of the product to a wish list or shopping list, combinations thereof, or the like. Because the interaction can be detected by the server computer 114 in additional and/or alternative ways, and because the user device 102 may inform the server computer 114 regarding the interaction, it should be understood that these examples are illustrative, and should not be construed as being limiting in any way.

The activity detected in operation 202 also can correspond to the device arriving at, moving within, moving near, or otherwise being associated with a geographic location, venue, or other location. As explained above, the server computer 114 can detect that a device such as the user device 102 has arrived at, moved within, or exited a particular geographic location such as the location 120 based upon data received from the user device 102, data received from the location device 122, other information, combinations thereof, or the like. As noted above, the location devices 122 can determine, based upon the collected data, that the user device 102 has arrived at, moved within, or exited a location associated with a vendor store, office, or other location, and provide the information to the rating service 112. Because the server computer 114 can determine that the user device 102 has arrived at a location in additional and/or alternative ways, it should be understood that these embodiments are illustrative, and should not be construed as being limiting in any way.

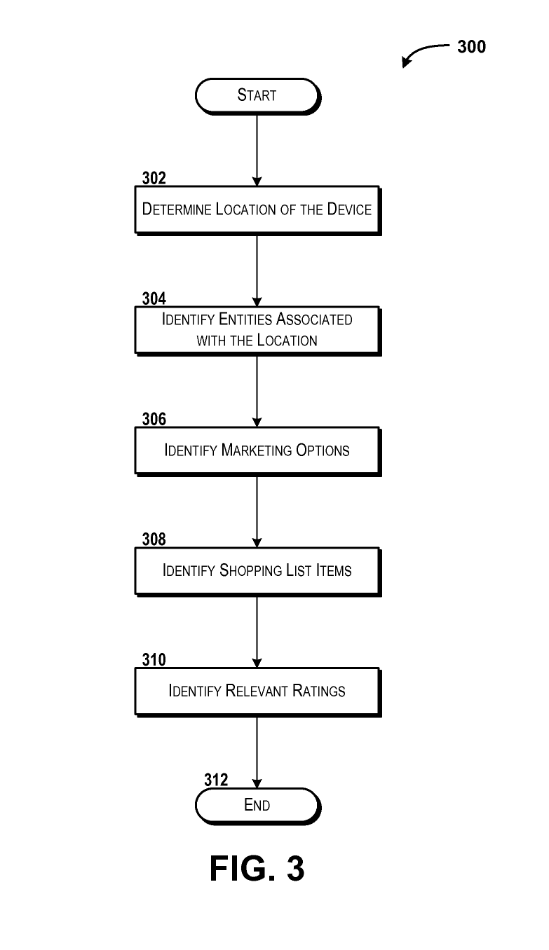

From operation 202, the method 200 proceeds to operation 204. At operation 204, the server computer 114 identifies a rating 116. According to various embodiments of the concepts and technologies described herein, the server computer 114 can identify, in operation 204, one or more ratings 116 that is or are relevant to the activity detected in operation 202. Thus, it can be appreciated that the ratings 116 identified in operation 204 can be based upon a location, a vendor, a product, a service, an activity, a rater, a rating, a venue, and/or various data associated with a particular entity such as the rater, cost, relative cost, or the like. Thus, although not shown in FIG. 2, it should be understood that the server computer 114 can collect contextual information that indicates a location, date, time, customer, combinations thereof, or the like. Additional aspects of identifying the rating 116 will be illustrated and described in additional detail below with reference to FIG. 3.

From operation 204, the method 200 proceeds to operation 206. At operation 206, the server computer 114 can determine if the rating 116 identified in operation 204 is to be provided to a device such as the device associated with the activity detected in operation 202 or other devices. In some instances, a rating 116 may not be provided to the device, for example, if the device leaves an area with which the rating 116 is associated, if the user indicates that no rating 116 is desired for viewing, combinations thereof, or the like.

In some embodiments, the server computer 114 determines that the rating 116 is to be provided based upon determining that the rating 116 is relevant to the user or other entity. This determination may be based, for example, upon an explicit rating request 110, input from the user device 102 indicating that the rating 116 is to be viewed, combinations thereof, or the like. Because the determination as to whether or not to show the rating 116 can be made in additional or alternative ways, it should be understood that these examples are illustrative and therefore should not be construed as being limiting in any way.

If the server computer 114 determines, in operation 206, that the rating identified in operation 204 is to be provided to the device, the method 200 can proceed to operation 208. At operation 208, the server computer 114 can provide the rating 116 to the device. In various embodiments, the device that receives the rating 116 can generate an alert or notification such as, for example, the rating available alert 124 shown in FIG. 1. In some other embodiments, the rating service 112 can generate the rating available alert 124 and transmit the rating available alert 124 to the device instead of, or in addition to, the rating 116. Thus, in some embodiments the rating 116 may be accessed only if the rating 116 is of interest to a user or other entity associated with the device, while in some other embodiments the rating 116 may be provided to the device without providing the rating available alert 124 and/or by relying upon the device to generate the rating available alert 124. It should be understood that these examples are illustrative and therefore should not be construed as being limiting in any way.

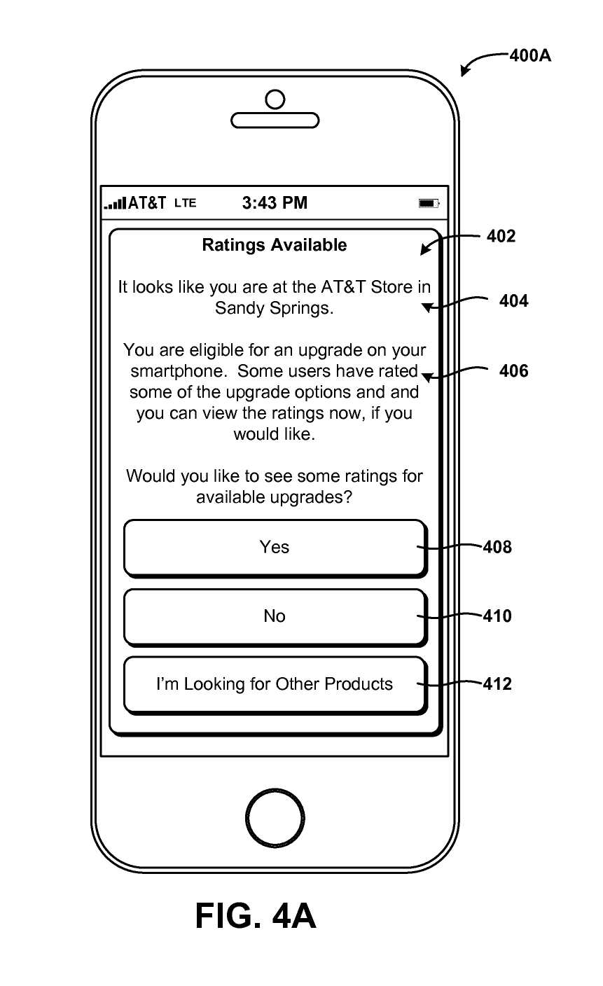

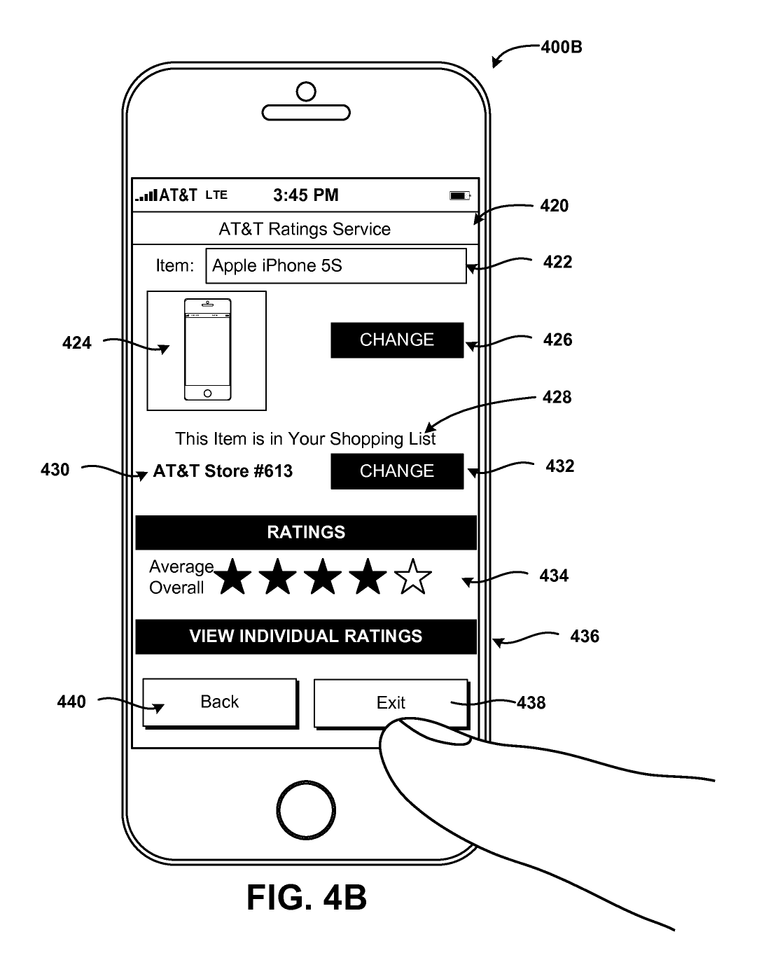

If the user or other entity elects not to view the rating 116, the method 200 can pause or terminate instead of proceeding to operation 208. If the user or other entity elects to view the rating or ratings 116, the method 200 can proceed to operation 208, and the device can present the rating 116, for example within a user interface, or the like. As noted above, the device may access the rating service 112 or other devices to obtain the rating 116 if the rating is not provided in operation 208 (e.g., if the rating available alert 124 is instead provided). One example interface for presenting a rating 116 is illustrated and described below with reference to FIG. 4B. Because additional and/or alternative methods of presenting the ratings 116 are contemplated and are possible, it should be understood that this example is illustrative and therefore should not be construed as being limiting in any way.

From operation 208, the method 200 proceeds to operation 210. The method 200 also can proceed to operation 210 if the server computer 114 determines, in operation 206, that the rating 116 identified in operation 204 is not be provided to the device. The method 200 ends at operation 210.

Turning now to FIG. 3, aspects of a method 300 for identifying a rating will be described in detail, according to an illustrative embodiment. It can be appreciated with reference to FIGS. 2-3 that the method 300 can, but does not necessarily, correspond to the functionality illustrated and described herein with respect to operation 204 of the method 200. It should be understood that this example is illustrative and therefore should not be construed as being limiting in any way.

The method 300 begins at operation 302. At operation 302, the server computer 114 determines a location of a device such as, for example, the device associated with the activity detected in operation 202 of the method 200. According to various embodiments of the concepts and technologies described herein, the server computer 114 can determine the location of the device in various manners. For example, the server computer 114 can query the device and request location information from the device. The device, in response to the request, can access a location or remote location determination device or system such as a global positioning system (“GPS”) receiver at the device, a location server accessible to the device, and/or other location determination devices or systems. Alternatively, the device may maintain location information and therefore may not obtain the location in response to the request. At any rate, the device can determine its location and provide the location to the server computer 114, in some embodiments.

In some other embodiments, the server computer 114 can access other location determination devices such as, for example, a location server, a home location register (“HLR”) of a cellular network, or the like. The location server or other device or node can track a location of the device and provide information indicating the location of the device to the server computer 114 periodically, on-demand, and/or at other times. In some other embodiments, as illustrated and described in FIG. 1, the server computer 114 can be configured to communicate with one or more location devices 122 associated with a location 120. Thus, the server computer 114 can communicate with location beacons, or the like. Because the server computer 114 can determine a location of the device in additional and/or alternative ways, it should be understood that these examples are illustrative and therefore should not be construed as being limiting in any way.

From operation 302, the method 300 proceeds to operation 304. At operation 304, the server computer 114 identifies entities associated with the determined location. According to various embodiments, the server computer 114 can identify entities associated with the location determined in operation 302 by analyzing the ratings 116 and/or other data stored at the data store 118 or elsewhere. For example, the server computer 114 can analyze the ratings 116 to identify ratings 116 associated with the location determined in operation 302, and identify vendors, products, services, raters, venues, costs, activities, or the like associated with the location determined in operation 302.

In one contemplated example of the concepts and technologies described herein, the server computer 114 can determine the location as illustrated in operation 302, and search through the ratings 116 stored at the data store 118 to identify any ratings 116 associated with the location. Upon identifying the ratings 116 associated with the location, the server computer 114 can analyze the ratings 116 to identify vendors, dates, times, venues, raters, costs, products, services, or the like associated with the location. Because the entities associated with the determined location can be determined in other ways such as a lookup table, or the like, it should be understood that this example is illustrative and therefore should not be construed as being limiting in any way.

From operation 304, the method 300 proceeds to operation 306. At operation 306, the server computer 114 can identify marketing options, if any, associated with the location identified in operation 302. “Marketing options,” as used herein, can refer to an option to push ratings to users or devices when the users or devices approach or enter a location. The marketing options can be configured by vendors, providers, network operators, users, or the other entities. In some embodiments, entities such as vendors, retailers, manufacturers, service providers, or the like may wish to push marketing or other information such as ratings to users or devices that enter a vicinity or venue associated with the entities.

Thus, for example, a mobile phone manufacturer with a positive rating or review may elect to push the rating or review to a device that is near or enters a store or other location that sells or services mobile phones made by the mobile phone manufacturer. Thus, users that may be interested in purchasing the mobile phone (by virtue of their arriving at and/or entering the location or venue associated with the mobile phone) may receive a rating 116 associated with the mobile phone. In some embodiments, providing ratings 116 in this manner may increase sales or the likelihood of sales associated with the mobile phone or other products, services, activities, items, or other entities. As such, it can be appreciated that the server computer 114 can determine, in operation 306, if ratings 116 or other information are to be pushed to the device identified in operation 302. It should be understood that this example is illustrative and therefore should not be construed as being limiting in any way.

From operation 306, the method 300 proceeds to operation 308. At operation 308, the server computer 114 can identify shopping list items. While FIG. 3 illustrates a “shopping list,” it should be understood that other types of lists can be used or accessed in accordance with various embodiments of the concepts and technologies described herein. In particular, in one embodiment of the concepts and technologies described herein, the server computer 114 can analyze a shopping list or other product or service list such as a wish list, a shopping cart, a to-do list, a bookmark or favorites collection, combinations thereof, or the like, associated with the device identified in operation 302. The list analyzed in operation 308 can be provided, for example, by the user device 102 via execution of the rating application 108, by a web-based or device-based list program, a shopping cart, a wish list, combinations thereof, or the like.

In some embodiments, the server computer 114 can analyze a shopping list or other list associated with the device and determine, based upon the shopping list contents and ratings 116 associated with the location determined in operation 302, if the device is at or near a location at which a product, service, activity, or other item or entity on the list can be purchased or obtained. For example, if a shopping list includes an entry for a smartphone, and the location determined in operation 302 corresponds to ratings 116 associated with an AT&T Store or other mobile device retail location, the server computer 114 can determine that the user may be at the location to purchase a new cellular phone, or the like. Thus, shopping lists, wish lists, shopping carts, combinations thereof, or the like, can be analyzed by the server computer 114 to identify ratings 116 that may be relevant to a device user or other entity. It should be understood that these examples are illustrative and therefore should not be construed as being limiting in any way.

From operation 308, the method 300 proceeds to operation 310. At operation 310, the server computer 114 can identify relevant ratings 116. Based upon the functionality of the server computer 114 illustrated and described herein with reference to operations 302-308, it can be appreciated that the server computer 114 can identify relevant ratings 116 based upon a location of the device; one or more vendors, retailers, and/or other entities associated with the location at which the device is located; marketing and/or push notification options associated with the vendors, retailers, and/or other entities associated with the location; shopping lists, wish lists, shopping cart contents, bookmark lists, favorite lists, and/or other lists associated with the device; combinations thereof; or the like. Thus, operation 310 can correspond to the server computer 114 analyzing the data collected in operations 302-308 and identifying, based upon these and/or other data, ratings 116 that are expected or known to be relevant to the device and/or a user thereof. It should be understood that this example is illustrative and therefore should not be construed as being limiting in any way.

Although not shown in FIG. 3, the identified ratings 116 can be provided to the device. According to various embodiments, wherein the method 300 can be executed in accordance with operation 204 of the method 200, operation 310 can be followed by operation 206. It should be understood that this example is illustrative and therefore should not be construed as being limiting in any way.

From operation 310, the method 300 proceeds to operation 312. The method 300 ends at operation 312.

FIGS. 4A-4B are user interface (“UI”) diagrams showing aspects of UIs for providing receiving and presenting ratings 116 provided by a rating service 116, according to some illustrative embodiments. FIG. 4A shows an illustrative screen display 400A generated by a device such as the user device 102. According to various embodiments, the user device 102 can generate the screen display 400A and/or other screen displays in conjunction with and/or based upon data received from the rating service 112 described herein. It should be appreciated that the UI diagram illustrated in FIG. 4A is illustrative of one contemplated example of the UIs that can be generated and/or displayed in accordance with the concepts and technologies disclosed herein, and therefore should not be construed as being limited in any way.

The screen display 400A can include various menus and/or menu options (not shown in FIG. 4A). The screen display 400A also can include a rating available alert display or window (hereinafter referred to as the “rating available alert display 402”). The rating available alert display 402 can be used to indicate, to a user or other entity associated with the device, that a rating 116 is available. Thus, the rating available alert display 402 can correspond to one embodiment of the available rating alert 124 illustrated and described in FIG. 1.

As explained above in detail with reference to FIG. 1, it should be understood that the available rating alert 124 can include blinking lights, displays, LEDs, or the like; sounds, rings, beeps, or the like; tactile alerts such as vibration or the like; as well as user interface elements and/or screen displays such as the screen display 400A shown in FIG. 4A. As such, it should be understood that the rating available alert display 402 is illustrative of only one example of the available rating alert 124 and therefore should not be construed as being limiting in any way.

It should be appreciated that the screen display 400A can be presented, for example, in response to receiving a rating available alert 124 at the user device 102 from the rating service 112 as explained above with reference to FIG. 1. Because the screen display 400A illustrated in FIG. 4A can be displayed at additional and/or alternative times, it should be understood that this example is illustrative and therefore should not be construed as being limiting in any way. It should be understood that this embodiment is illustrative, and should not be construed as being limiting in any way.

The rating available alert display 402 can explain that a rating 116 is available and/or relevant to a location or other activity associated with the user and/or a device associated with the user. In the illustrated embodiment, the rating available alert display 402 includes an indication 404 of a location or venue (e.g., the location 120) at which the device is located or to which the device is near, as well as another indication 406 that can explain an item or product for which the rating 116 is available. In the illustrated embodiment, the indication 404 indicates that the device is located at or near an AT&T Store, and the other indication 406 indicates that ratings 116 are available for an upgraded smartphone. It should be understood that this example is illustrative and therefore should not be construed as being limiting in any way.

In some embodiments, the rating available alert display 402 can include incentives for the user viewing the ratings 116, though this is not necessarily the case. Thus, for example, vendors or other entities associated with the ratings 116 may offer incentives, discounts, or other deals to users who view or access ratings 116 with the assumption that positive ratings 116 may trigger a sale or upsell, though this is not necessarily the case. Because the rating available alert display 402 can include additional or alternative indicators and additional or alternative incentives, it should be understood that this example is illustrative and therefore should not be construed as being limiting in any way.

The rating available alert display 402 can include a UI control 408 for viewing the rating 116 indicated by the rating available alert display 402, a UI control 410 for declining to view the rating 116 indicated by the rating available alert display 402, a UI control 412 for indicating that the rating 116 indicated as being relevant by the other indication 406 is not actually relevant to the user, other UI controls (not shown), combinations thereof, or the like.

It can be appreciated from the above description of FIGS. 1-3 that selection of the UI controls 408-412 can cause the user device 102 to provide input to the server computer 114 and/or to prompt the rating application 108 to generate displays for presentation to the user or other entity. Selection of the UI control 408 also can cause the device to download or otherwise access the rating 116, as explained above. Because additional and/or alternative actions can be taken in response to selection of one or more of the UI controls 408-412, It should be understood that these embodiments are illustrative, and should not be construed as being limiting in any way.

Referring now to FIG. 4B, a UI diagram showing additional aspects of the concepts and technologies disclosed herein for providing ratings 116 using a rating service 112 are described in detail. In particular, FIG. 4B shows an illustrative screen display 400B generated by a device such as the user device 102. It should be appreciated that the UI diagram illustrated in FIG. 4B is illustrative of one contemplated example of the UIs that can be generated and/or displayed in accordance with the concepts and technologies disclosed herein, and therefore should not be construed as being limited in any way.

The screen display 400B can include a rating presentation display 420. The rating presentation display 420 can be used to present one or more ratings 116 to a user or other entity. It can be appreciated that the rating presentation display 420 can be presented in response to a user selecting the UI control 408 shown in FIG. 4A. Because the rating presentation display 420 can be displayed at additional and/or alternative times, it should be understood that this embodiment is illustrative, and should not be construed as being limiting in any way.

The rating presentation display 420 can include an item indicator 422. The item indicator can indicate a product, service, activity, venue, service provider, and/or other entity with which the rating 116 presented by way of the rating presentation display 420 is associated. The illustrated embodiment of the rating presentation display 420 includes a thumbnail image 424 of the entity with which the rating 116 presented by way of the rating presentation display 420 is associated. It should be understood that this example is illustrative and therefore should not be construed as being limiting in any way.

The rating presentation display 420 also can include a UI control 426 for changing a selection of the entity with which the rating 116 presented by way of the rating presentation display 420 is associated. Thus, a user may select an option to view the rating 116 and discover, upon presentation of the rating 116 and/or at another time, that the entity with which the rating 116 presented by way of the rating presentation display 420 is associated is not relevant to the activity of the user. Thus, the UI control 426 can be used to change the entity with which the rating 116 presented by way of the rating presentation display 420 is associated. It should be understood that this example is illustrative and therefore should not be construed as being limiting in any way.

The rating presentation display 420 also can include an entity source indicator 428. The entity source indicator 428 can indicate how the rating service 114 determined that the entity with which the rating 116 presented by way of the rating presentation display 420 is associated was selected. In the illustrated embodiment, the entity source indicator 428 indicates that the entity was identified by way of a shopping list associated with the user. As explained above with regard to FIG. 3, the shopping list and/or other source of information can be analyzed with location information, shopping history, known vendors or other entities associated with ratings 116, combinations thereof, or the like. Additionally, or alternatively, the ratings 116 can be provided based upon marketing options indicated by the user, a vendor, or other provider, or the like. As such, the illustrated embodiment, wherein the entity source indicator 428 indicates the source of the entity as a shopping list, should be understood as being illustrative of one embodiment and should not be construed as being limiting in any way.

The rating presentation display 420 also can include a location indicator 430 and a UI control 432 for changing the location. The location indicator 430 can indicate a location at which the device is located. From the description of FIG. 3 above, it can be appreciated that the location indicated by the location indicator 430 can correspond to the location determined in operation 302 of the method 300 if desired, though this is not necessarily the case. The UI control 432 can be used to change or update the location, if desired.

The rating presentation display 420 also includes a rating indicator 434, which can indicate an average overall rating for the entity associated with the rating 116. Although not shown in FIG. 4B, it should be understood that the rating indicator 434 can indicate an average rating as well as a number of ratings 116 represented by the average rating. The rating presentation display 420 also can include a UI control 436 for accessing individual ratings instead of an average rating. Selection of the UI control 436 can cause the device to present multiple ratings 116, if desired.

The screen display 400B also can include a UI control 438 for exiting the presentation of the review and a UI control 440 for returning to a previous screen display such as the screen display 400A shown in FIG. 4A. Thus, selection of one of the UI controls 438, 440 can cause the device to hide the screen display 420 and display other screen displays. It should be understood that this example is illustrative and therefore should not be construed as being limiting in any way.

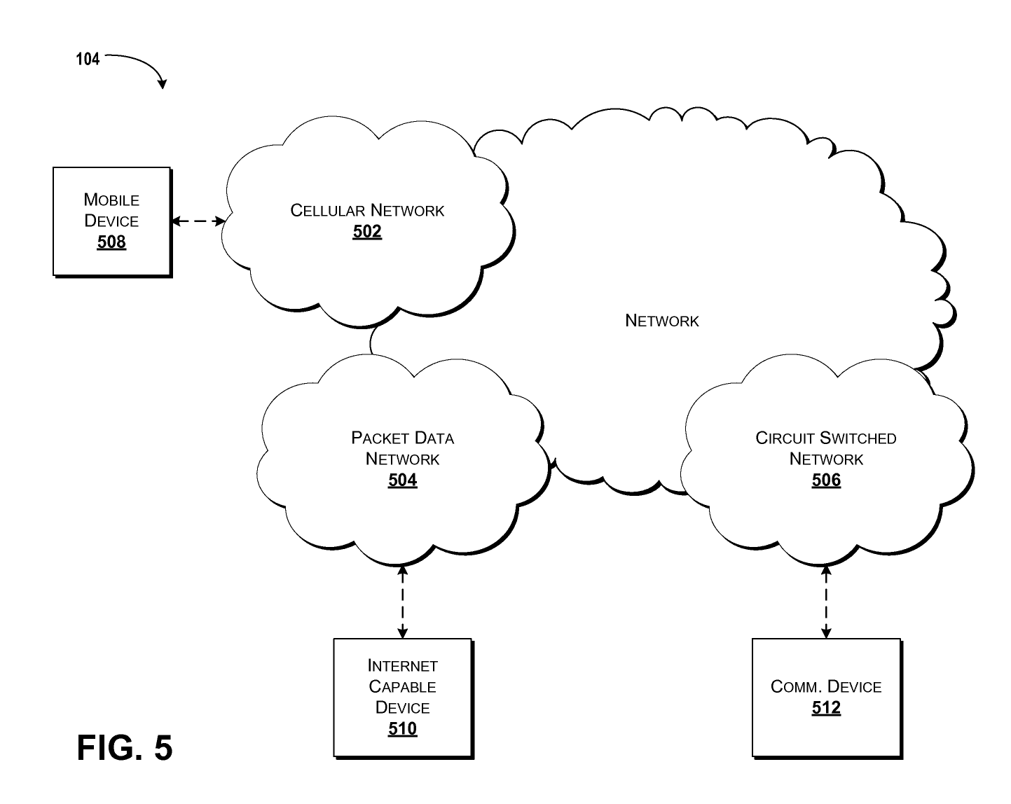

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards as well as evolved and future mobile standards.

The packet data network 504 includes various devices, for example, servers, computers, databases, and other devices in communication with another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

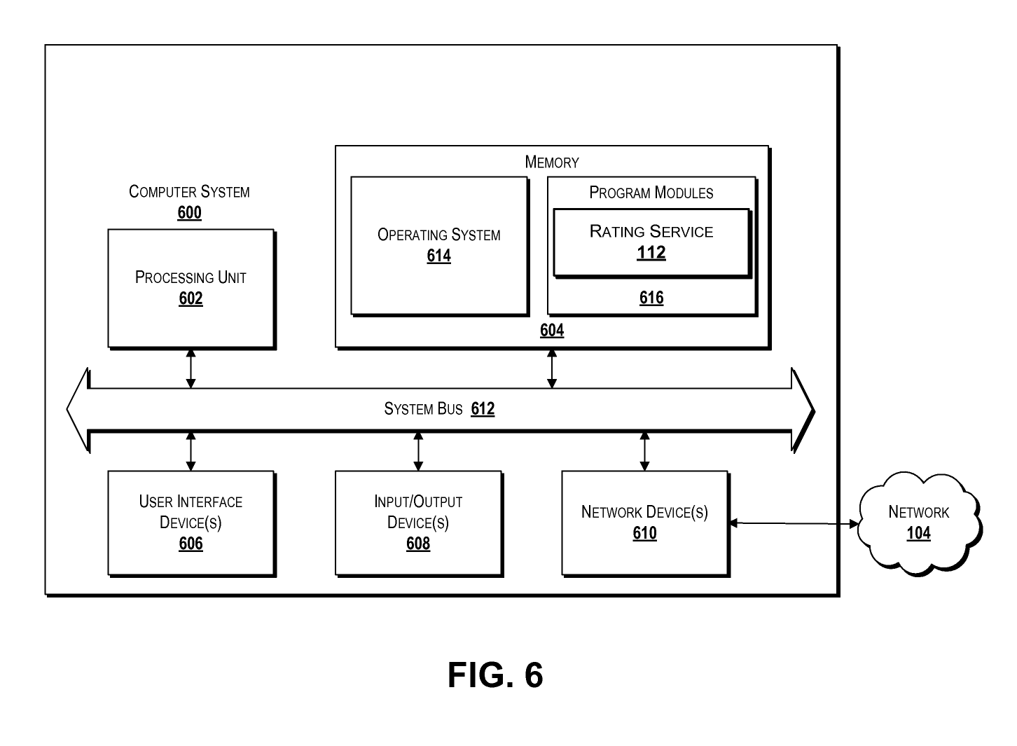

FIG. 6 is a block diagram illustrating a computer system 600 configured to provide the functionality described herein for providing ratings using a rating service, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the rating service 112. This and/or other programs can be embodied in computer-readable media containing instructions that, when executed by the processing unit 602, perform one or more of the methods 200, 300 described in detail above with respect to FIGS. 2-3. According to embodiments, the program modules 616 may be embodied in hardware, software, firmware, or any combination thereof. Although not shown in FIG. 6, it should be understood that the memory 604 also can be configured to store the ratings 116, the rating requests 110, the rating application 108, the rating available alert 122, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 7, an illustrative mobile device 700 and components thereof will be described. In some embodiments, the user device 102 described above with reference to FIGS. 1-5 can be configured as and/or can have an architecture similar or identical to the mobile device 700 described herein in FIG. 7. It should be understood, however, that the user device 102 may or may not include the functionality described herein with reference to FIG. 7. While connections are not shown between the various components illustrated in FIG. 7, it should be understood that some, none, or all of the components illustrated in FIG. 7 can be configured to interact with one other to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements for ratings 116, rating requests 110, providing rating available alerts 124, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710 such as the rating application 108, other computer-executable instructions stored in a memory 708, or the like. In some embodiments, the applications 706 also can include a UI application (not illustrated in FIG. 7).

The UI application can interface with the operating system 708, such as the operating system 106 shown in FIG. 1, to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, viewing rating available alerts 124, viewing ratings 116, requesting ratings 116 and/or generating the rating requests 110, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, for example, ratings 116 and/or other data, applications, or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interfaced 716 can be configured to support the input/output of data such as location information, rating requests 110, ratings 116, rating available alerts 124, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ411) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

Based on the foregoing, it should be appreciated that systems and methods for providing ratings using a rating service have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

We claim:

1. A method comprising:
detecting, at a server computer executing a rating service, an activity associated with a user device;
identifying, by the server computer, a rating associated with the activity;
determining, by the server computer, if the rating is to be provided to the user device; and
if a determination is made that the rating is to be provided to the user device, providing, by the server computer, the rating to the user device.

2. The method of claim 1, wherein the activity comprises arrival at a geographic location, and wherein the rating is associated with the geographic location.

3. The method of claim 2, wherein the rating comprises data identifying the geographic location and an item associated with the geographic location.

4. The method of claim 1, wherein the activity comprises an interaction with an item, and wherein the rating is associated with the item.

5. The method of claim 4, wherein the interaction comprises a web search relating to the item and a price search relating to the item.

6. The method of claim 5, wherein identifying the rating comprises determining that the item is included in a shopping list associated with the user device.

7. The method of claim 1, further comprising determining a location of the user device, wherein detecting the activity comprises determining that the user device has arrived at the location.

8. The method of claim 7, wherein determining the location of the user device comprises receiving an indication, from a location device located at the location, that the user device has arrived at the location.

9. The method of claim 8, wherein the location device comprises a wireless location beacon.

10. The method of claim 1, wherein identifying the rating comprises identifying a marketing option associated with a vendor, the marketing option indicating that a rating is to be provided to the user device.

11. The method of claim 1, wherein providing the rating to the user device comprises providing, to the user device, data that causes the user device to generate a rating available alert and data corresponding to the rating.

12. The method of claim 11, wherein the rating available alert comprises an alert selected from the group consisting of a visual alert, a tactile alert, and an audio alert.

13. A system comprising:
a processor; and
a memory that stores computer-executable instructions that, when executed by the processor, cause the processor to perform operations comprising
detecting an activity associated with a user device,
identifying a rating associated with the activity,
determining if the rating is to be provided to the user device, and
if a determination is made that the rating is to be provided to the user device, providing the rating to the user device.

14. The system of claim 13, further comprising a data store that stores ratings comprising the rating, and wherein identifying the rating comprises analyzing the ratings to identify an entity associated with a location at which the user device is located, identifying an item on a shopping list associated with the user device, and determining that a rating relating to the item is available.

15. The system of claim 13, wherein the activity comprises arrival at a geographic location associated with an item and interaction with the item.

16. The system of claim 15, wherein identifying the rating comprises determining that a vendor associated with item requests that the rating be provided to the user device.

17. A computer storage medium having computer-executable instructions stored thereon that, when executed by a processor, cause the processor to perform operations comprising:
detecting an activity associated with a user device;
identifying a rating associated with the activity;
determining if the rating is to be provided to the user device; and
if a determination is made that the rating is to be provided to the user device, providing the rating to the user device.

18. The computer storage medium of claim 17, wherein identifying the rating comprises analyzing social networking messages associated with the user device to identify an item, analyzing ratings stored in a data store to identify an entity associated with a location at which the user device is located, identifying the entity as being associated with the item, and determining that ratings relating to the item are available.

19. The computer storage medium of claim 17, wherein the computer-executable instructions further comprise instructions that, when executed by the processor, cause the processor to perform operations further comprising:
providing data to the user device, wherein the data causes the user device to generate a rating available alert at the user device.

20. The computer storage medium of claim 19, wherein the rating available alert comprises a vibration alert and a visual alert.
